(19) United States
(12) Patent Application Publication
(10) Pub. No.: US 2008/0283713 A1
(43) Pub. Date: Nov. 20, 2008

(54) Support Particularly for Optical or Photographic Use

(75) Inventor: Paolo Speggiorin, Mussolente (VI) (IT)

Correspondence Address: RATNERPRESTIA, P O BOX 980, VALLEY FORGE, PA, 19482-0980, US

(73) Assignee: LINO MANFROTTO & CO., S.P.A., BASSANO DEL GRAPPA (IT)

(21) Appl. No.: 12/159,109

(22) PCT Filed: Dec. 22, 2006
(86) PCT No.: PCT/IT06/00869

§ 371 Date: Jun. 25, 2008

(30) Foreign Application Priority Data
Dec. 28, 2005 (IT) PD2005A00381
Aug. 7, 2006 (IT) PD2006A000305

(51) Int. Cl. F16M 11/24

(52) U.S. Cl. 248/439

(57) ABSTRACT

A support (1), includes at least one telescopic leg (2a), comprising a first tubular segment (4), a second tubular segment (5), a third tubular segment (6) first segment, first locking means (9) arranged between the first and the second segment, second locking means (10a) arranged between the second and third segment, and also first (90) and second (110a) release means capable of unlocking the sliding movement in the insertion direction of the second and third segment respectively in the first and second segment. The second release means comprise an actuating member (11) axially slidable on the outside of the second and third segment, and the first release means are dimensioned such as to locate the actuating member and to displace it axially into the operating position when the second segment is inserted axially into the first segment.

### TECHNICAL FIELD

The subject of the present invention is a support particularly, but not exclusively, for optical or photographic use, of the type including the characteristics mentioned in the preamble of the main claim.

### TECHNOLOGICAL BACKGROUND OF THE INVENTION

In this technical field it is known to produce supports for cameras, such as single-leg stands or tripods, provided with telescopic legs, adjustable without substantial resistance in the direction of elongation and subject to automatic locking in the opposite direction, i.e. the retraction direction. With such supports it is possible to reduce to a minimum the effort of the operator in the setting-up phase and to effect the locking of the legs solely by means of the effect of the load supported thereby.

The automatic locking of the legs is effected by means of a plurality of devices, each of which acts on each pair of consecutive segments which constitute each leg of the support.

This solution allows the operator, in the phase of adjustment of the height of the support, to reduce the length of each leg of the support by deactivating each of said locking devices independently of the others.

The main drawback with regard to the constructional technique described above lies in the fact that when the operator wishes to completely retract a single leg, in order to use it at its minimum length, or to put it into the configuration for transport, he must however deactivate, one by one, all the locking devices contained in the leg itself, by acting directly on each one.

### DESCRIPTION OF THE INVENTION

The technical problem underlying this invention is that of providing an adjustable telescopic support structurally and functionally designed so as to enable the drawbacks mentioned with reference to the prior art described to be remedied.

This problem is solved by the present invention by means of a support produced according to the claims which follow.

### BRIEF DESCRIPTION OF THE DRAWINGS

The characteristics and advantages of the invention will become clearer from the detailed description of some preferred exemplary embodiments thereof, illustrated by way of non-limiting examples with reference to the appended drawings, in which:

FIG. 1 is a side view of a support produced according to the present invention;

FIG. 2 and FIG. 3 are two side views of a leg of the support of FIG. 1 in two different operating positions;

FIG. 4 is a sectional view of a detail of the support of FIG. 1;

FIG. 5 is a sectional view of a further detail of the support of FIG. 1;

FIG. 6 is a sectional view of a detail of a constructional variant of the detail of FIG. 4;

FIG. 7 is a sectional view of the detail of FIG. 6, in a different operating configuration.

### PREFERRED WAYS OF IMPLEMENTING THE INVENTION

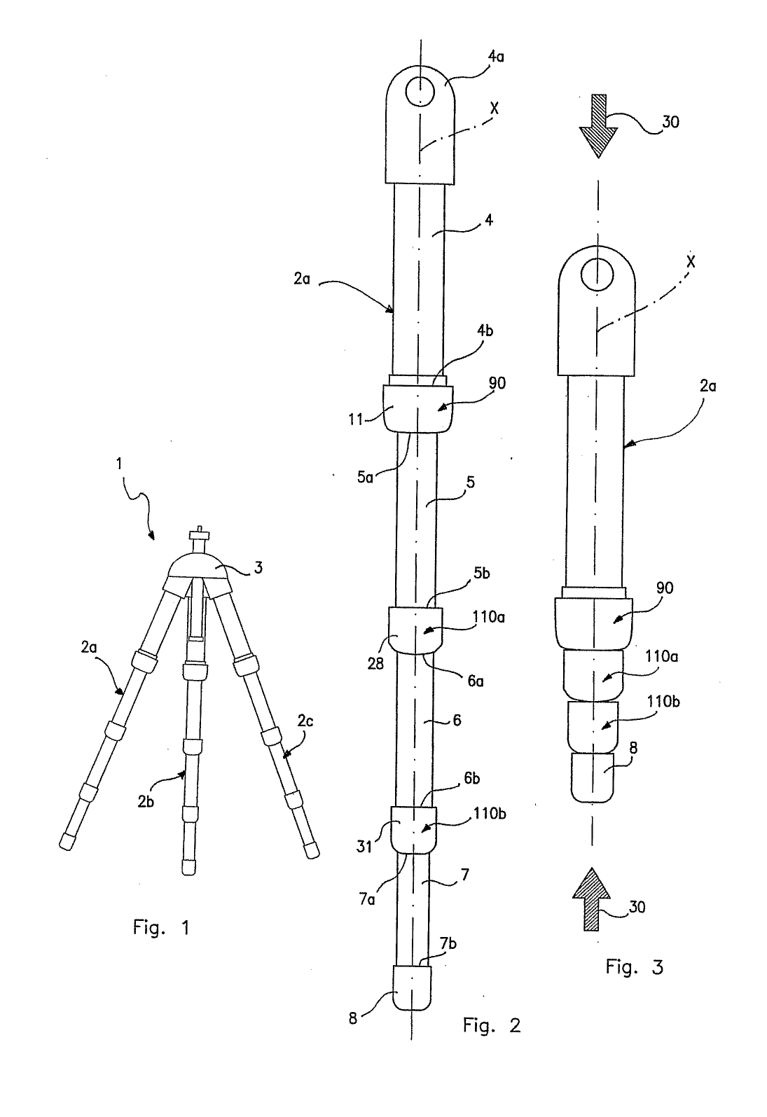

With initial reference to FIGS. 1, 2 and 3, the reference 1 indicates as a whole a support, in the preferred example illustrated, a tripod, for optical or photographic use, produced according to the present invention and comprising three telescopic legs 2a, 2b, 2c converging in a spider 3. It is to be understood that other supports, such as single-leg stands, poles, etc. for optical or cinematographic equipment may be used in the present invention without modification thereof, provided that they include at least one telescopically extendable leg.

The three legs are preferably substantially identical to one another, therefore only one of them, in particular the leg 2a, is illustrated in FIGS. 2 and 3 in two different operating configurations termed, respectively, completely extended and completely retracted.

The leg 2a extends along an axis X and comprises a first 4, a second 5, a third 6 and a fourth 7 tubular segment described in detail hereinafter. The first tubular segment 4 is provided with a longitudinal end 4a, hinged to the spider 3, and with an opposed longitudinal end 4b. The second tubular segment 5 is slidably inserted at a longitudinal end 5a thereof into the first segment 4, at its end 4b. The third tubular segment 6 is slidably inserted at a longitudinal end 6a thereof into the second segment 5, at the end 5b, longitudinally opposed to the end 5a. Finally, the fourth tubular segment 7 is slidably inserted at a longitudinal end 7a thereof into the third segment 6, at the end 6b, longitudinally opposed to the end 6a. Preferably, the fourth segment 7 has at one end 7b, longitudinally opposed to the end 7a, a support foot 8 for the tripod 1.

It is to be understood that the number of segments comprised in each leg 2a, 2b, 2c of the support 1 may be arbitrary; for the implementation of the invention it is sufficient for the segments per leg to be three or more in number.

The first and the second segment 4 and 5 are slidably guided in each other and are lockable in any desired relative positions by means of first locking means 9 fitted between them.

Similarly, the second and third segments 5 and 6, and the third and fourth segments 6 and 7, are slidably guided in each other and are lockable in any desired relative positions by means of, respectively, second and third locking means 10a, 10b fitted between them.

Each of the first, second and third locking means 9, 10a, 10b is capable of locking the sliding movement of the second, respectively third and fourth, segment 5, 6, 7 in an axial sliding direction. The segments 5, 6, 7 preferably slide along the axis X of extension of the leg and the axial direction in which the sliding movement of the segments is locked by corresponding locking means is referred to hereinafter as the axial insertion direction, being the direction in which one segment is inserted into the adjacent segment.

Preferably, the third locking means 10b are functionally and constructionally similar to the second means 10a, but are produced with smaller dimensions than the latter.

In addition, the support 1 comprises, for each of the first, second and third locking means 9, 10a, 10b, corresponding first 90, second 110a and third 110b release means, each of the release means being capable of unlocking the axial sliding of the second segment inside the first, respectively of the third inside the second, and of the fourth inside the third, in the axial insertion direction.

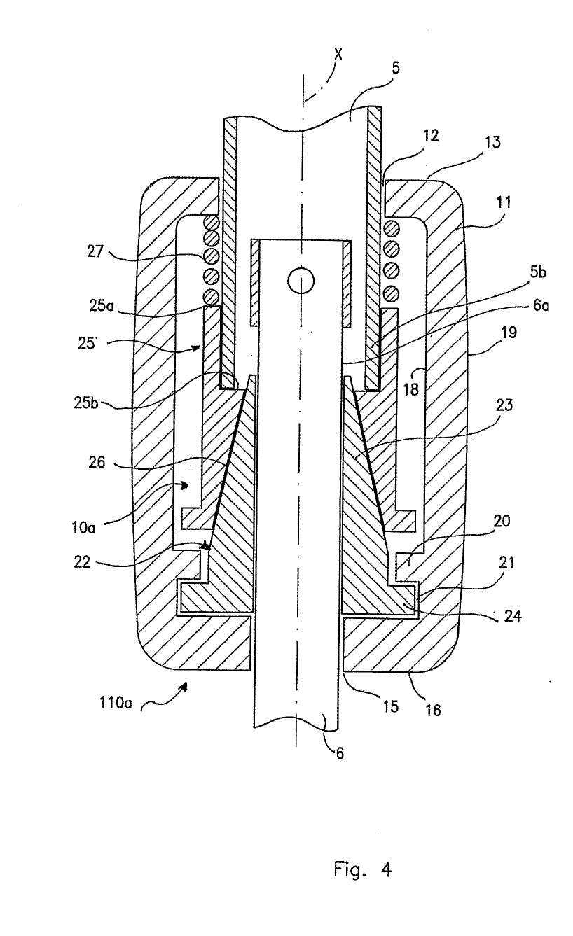

With reference to FIG. 4, the second release means 110a comprise an actuating member, in the preferred example in the shape of a hollow sleeve 11, axially slidable on the outside of the second 5 and third segment 6, and located at the end 5b of the segment 5.

The sleeve 11 is in particular displaceable axially along the axis X from a rest position to an operating position reached from the rest position by means of axial sliding in a direction opposed to the insertion direction defined above. In the rest position of the sleeve 1a, the release means 110a are inactive and the corresponding locking means 10a prevent the insertion of the third segment 6 into the second segment 5, while in the operating position of the sleeve 11 the release means 110a act on the locking means 10a, unlocking the latter and therefore permitting the aforesaid insertion.

In an exemplary embodiment illustrated with reference to FIG. 4, the sleeve 11 structurally has a substantially cylindrical configuration comprising a side wall substantially parallel to the axis X and defining an inner surface 18 and an outer surface 19, and also two base walls, upper 13 and lower 16 which close the side wall at the two opposed axial ends. Each base wall 13, 16 comprises a central aperture 12, 15 for the sliding movement within it of the second and third segment 5, 6 respectively.

In addition, the sleeve 11 comprises a radial protuberance 20 which projects from the inner surface 18 and is located close to the lower base wall 16. The protuberance 20, the lateral surface 18 and the lower base wall 16 define, within the sleeve 11, an annular seat 21.

The locking means 10a comprise, inside the sleeve 11, a collar 22 slidably mounted on the third segment 6. The collar 22 comprises, at a longitudinal end thereof, facing towards the second segment 5, a radially contractile portion 23, for example a frustoconical portion having a diameter increasing in a direction away from the second segment, and capable, when contracted, of clamping the third segment 6 and preventing it from sliding.

The collar 22 further includes, at the opposite longitudinal end, a radial protuberance 24 which engages in the seat 21 of the sleeve 11. The coupling between the protuberance 24 and the seat 21 renders the collar 22 secured to the sleeve 11 with respect to the axial sliding movement.

The locking means 10a likewise comprise, at the end 5b of the second segment 5, a machined bush 25 rigidly secured thereto. The bush 25 includes an annular shoulder 25b which restricts its inside diameter and on which abuts the end 5b of the segment 5, and a seat 26 capable of receiving the radially contractile portion 23 for clamping same. In particular, according to the preferred example illustrated, the seat 26 comprises at least one surface inclined with respect to the axis X so as to provide an axial contraction of the collar 22 with respect to the seat in the insertion direction. Specifically, the seat 26 comprises a frustoconical portion open in the direction of the third segment 6.

Between a longitudinal end 25a of the bush 25 facing towards the spider 3 and the upper base wall 13 of the sleeve 11, resilient means 27 act, for example a helical spring having an axis coinciding with the axis X, which, by the effect of a bias, pushes the bush 25 towards the foot 8 of the leg 2a, and at the same time pushes the sleeve 11, to which the collar 22 is slidably coupled, towards the spider 3.

By the effect of the bias action of the spring 27, the frustoconical portion 23 of the collar 22 is forced in the seat 26, effecting the one-way locking of the segment 6 with respect to the segment 5. At the same time, the sleeve 11 of the second release means 110a is urged into the rest position.

The bias of the spring is dimensioned such that it can easily be cancelled out by a tensile force acting between the segments 5 and 6 to draw out the latter from the former and applied manually by the operator in order to extend the leg 2a.

When the support 1 is in use, in the case where an axial thrust force is applied in the insertion direction, such as that determined by the weight of the tripod 1 and of the equipment supported, between the second and third segment 5 and 6, the frustoconical portion 23 of the collar 22 is pushed mainly against the seat 26, contracting radially towards the third segment 6 and locking the axial sliding movement thereof with respect to the second segment 5.

In order to unlock the relative sliding movement between the segments 5 and 6 in the direction of retraction of the leg 2a, it is sufficient for the operator to act on the second release means 110a, i.e. to push the sleeve 11 towards the foot 8, translating it and therefore bringing it from the rest position to the operating position for unlocking: owing to the coupling between the protuberance 24 of the collar 22 and the annular seat 21 of the sleeve 11, the frustoconical portion 23 of the collar 22 disengages from the seat 26, effecting the release of the segment 6 which can be inserted into the segment 5.

The third locking means 10b and also the third release means 110b are not illustrated in detail, inasmuch as they are preferably substantially similar to the devices 10a and 110a described above. It is to be understood, however, that their configuration, in a further exemplary embodiment, may also be substantially different and any locking and release device known in the field of reference may be used.

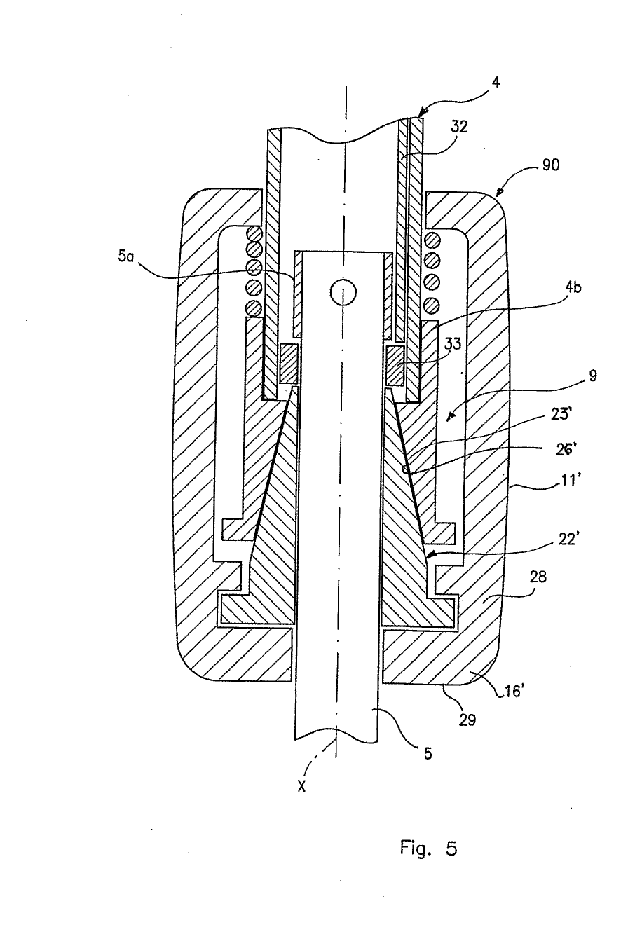

With reference now to FIG. 5, the first locking means 9 and the corresponding first release means 90 are illustrated.

According to an essential characteristic of the invention, the first release means 90 are structurally dimensioned so as to abut the actuating member 11 of the second release means 110a and to displace it axially into the operating position when the second segment 5 is inserted axially into the first segment 4.

The first locking device 9, provided the above condition is fulfilled, may have an arbitrary configuration: in particular, the locking means 9 may be identical to the means 10a, 10b, as illustrated in FIG. 5 in which members similar to those of the second release and locking means 110a, 10a are indicated by the same reference number followed by a prime.

According to a preferred example of the invention of FIG. 5, the first release means 90, in order to locate the actuating sleeve 11, comprise a surface 29, facing towards the locking device 10a, for example provided on a further sleeve 11′, similar to the sleeve 11 of the second means 110a. The surface 29, in the example illustrated, is the outer surface of the lower base wall 16′ of the further sleeve 11′.

In use, when the locking device 9 is deactivated, for example by means of axial translation of the further sleeve 11′ of the first release means 90, and a thrust force is applied to the leg 2a, represented by the arrow 30 in FIG. 3, the second segment 5 can slide inside the first segment 4 until the surface 29 of the actuating member 11′ is caused to abut the sleeve 11 of the second release means 110a, at the outer surface of the upper base wall 13. When the two surfaces abut each other, by continuing to apply a force 30, the sleeve 11 is moved in a direction opposed to the insertion direction. As described above, this effects the unlocking of the second locking means 10a and, by the effect of the continued application of the force 30, the sliding of the segment 6 inside the segment 5, until the lower base 16 of the sleeve 11 abuts a corresponding upper base of a corresponding sleeve of the third release means 110b of the leg 2a (not shown in detail).

This further abutment causes the actuation of the third release means 110b and therefore of the unlocking of the third locking means 10b by the effect of the displacement of the sleeve in a direction opposed to the insertion direction. The continued action of the thrust 30 effects the sliding of the fourth segment 7 inside the third segment 6 until the sleeve of the third release means 110b is caused to abut the foot 8, with the completely retracted configuration of the leg 2a, shown in FIG. 3, being obtained.

In one of the possible constructional variants of the support according to the invention, the first release device 90 is actuated by means of remote control operating means, so as to unlock the first locking means 9 (and consequently also the second and third means 10a, 10b) also by remote control.

Actuation is preferably provided by means of an unlocking rod which imparts an axial movement to the first locking means 9.

The remotely controlled release device 90, in a preferred exemplary embodiment thereof, includes as an unlocking rod a curved plate 32 extending longitudinally between the spider 3 and the end 4b of the segment 4, which is interposed between the first segment 4 and the second segment 5 with the latter sliding inside the former. The plate 32, at the end 4b, engages a bushing 33 slipped onto the second segment 5 and bearing on the frustoconical portion 23′ of the collar 22′. The displacement of the plate 32 by the effect of a remote mechanism (not shown), for example a mechanism actuated by a push-button located on the spider 3 or on the end of the leg closest to the equipment supported, towards the collar 22′ effects a corresponding thrust of the bushing 33 on the frustoconical portion 23′ with the consequent disengagement of the latter from the seat 26′. In this way it is possible to obtain the unlocking of the means 9 without the direct intervention of the operator on the actuating member 11′.

A further constructional variant of the invention (not shown) provides for the use of a single remote unlocking mechanism, for example a push-button mechanism actuated by a push-button located on the spider 3, acting at the same time on the first locking means 9 of each of the legs 2a, 2b, 2c of the tripod 1 so as to obtain with a single touch the rapid closure of the support 1.

It is to be understood that by “push-button” mechanism there is meant more generally all mechanisms for manual control by the user, such as, for example, pressure or lever switches, or touch screen, etc.

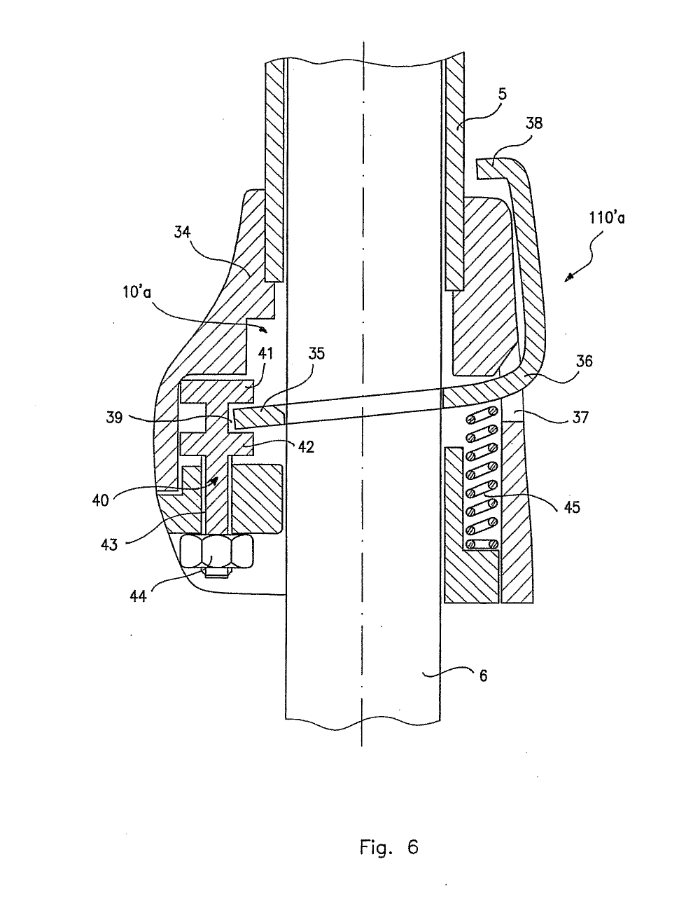

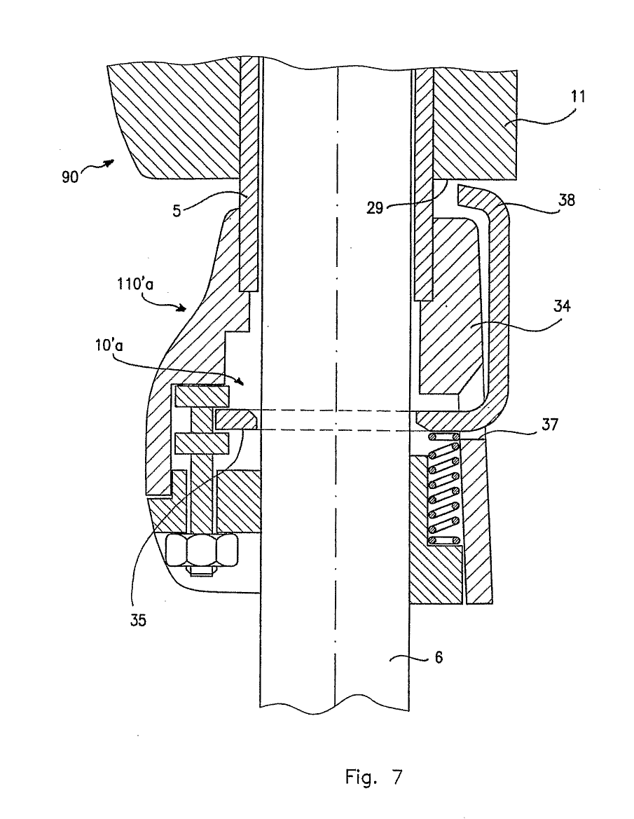

With reference to FIGS. 6 and 7, in a constructional variant thereof, the second locking means 10a′ comprise a casing 34, slipped integrally on the end 5b of the second segment 5, and a washer 35, slipped with play on the third segment 6, externally and coaxially thereto, positioned inside the casing 34. The washer 35 is provided with an appendage 36 passing through an aperture 37 of the casing 34, and provided with an end 38 facing towards the locking device 9 and which can be located by the actuating member 11′ of the first release device 90.

The appendage 36 constitutes second release means 110a′ of the locking means 10a′ and, by means of a movement thereof, in particular translation along the axis X in a direction opposed to the insertion direction (to which may be coupled a rotation), is capable of pivoting the washer 35 from a first, locking position in FIG. 6 in which the relative sliding movement between the second segment 5 and the third segment 6 is prevented by the friction produced by the contact between the washer and the third segment, and a release position in FIG. 7 in which the sliding movement is permitted, as detailed hereinafter.

The washer 35 is capable of pivoting with respect to an axis perpendicular to the axis X and is secured, at its radial end, inside a seat 39 defined by two radial protuberances 41, 42 of a pin 40 contained in the casing 34. The portion of washer 35 coupled to the seat 39 is located in a position diametrically opposed to the appendage 36. The pin 40 is threaded at the end opposed to that carrying the seat 39 and is coupled to a corresponding threaded hole 43, provided on the casing 34 and is locked in this position by means of a nut 44.

The locking device 10a′ further comprises, within the casing 34, resilient means, in particular a helical spring 45, with axis parallel to the axis X, which is biased and thrusting against a portion of the washer 35 close to the appendage 36.

At rest, by the effect of the action of the spring 45 and of the linkage with the seat 39, the washer 35 rotates about an axis perpendicular to the axis X so as to interfere with the segment 6, locking it by the effect of friction. The locking provided by this constructional variant is also of the one-way type, only in the insertion direction.

In order to unlock the locking means 10a′ it is necessary to act on the appendage 36, displacing it axially in a direction opposed to the insertion direction, which is also the direction of the thrust provided by the bias of is the spring 45. This displacement includes the corresponding rotation of the washer 35 towards a location mainly inclined with respect to the axis X, at the perpendicular limit with respect thereto, in which the interference between the washer 35 and the segment 6 is eliminated, permitting the sliding of the latter within the segment 5.

The displacement of the appendage 36 may be effected directly by the operator or by means of contact between the end 38 and the actuating member 11′ of the first release means 90.

The invention described above allows a video camera operator to rapidly retract the leg of a support by deactivating the first locking means 90 which prevent the relative sliding movement between the first and the second segment, and applying, subsequently, a thrust force between the ends of the leg itself. The deactivation of the first locking means may also be effected by means of a push-button remote control located on the spider or at the end of the leg closest to the equipment supported.

The present invention therefore solves the problem mentioned above with reference to the prior art cited, obtaining numerous advantages described above.

1. A support, particularly for optical or photographic use, including at least one telescopic leg, comprising a first tubular segment, a second tubular segment slidably inserted into said first segment, a third tubular segment slidably inserted into said second segment at the opposite end from said first segment, first locking means arranged between said first and second segment to lock the sliding movement of said second segment in said first segment in an axial insertion direction, second locking means arranged between said second and third segment to lock the sliding movement of said third segment in said second segment in said axial insertion direction, and also first and second release means associated respectively with said first and second locking means and capable of unlocking the sliding movement in said insertion direction respectively of said second and third segment in said first and second segment, wherein said second release means comprise an actuating member axially slidable on the outside of said second and third segment between a rest position and an operating position reached from said rest position by means of axial sliding in a direction opposed to said insertion direction and in which said second locking means are unlocked, and in that said first release means are dimensioned such as to locate said actuating member of the second release means and to displace it axially into said operating position when said second segment is inserted axially into said first segment.

2. The support according to claim 1, wherein said first release means comprise an actuating member slidable axially on the outside of said first and second segment between a rest position and an operating position, reached from said rest position by means of axial sliding in a direction opposed to said insertion direction, in which said first locking means are unlocked.

3. The support according to claim 2, wherein said actuating member is urged into said rest position by resilient means.

4. The support according to claim 2, wherein said actuating member is in the shape of a sleeve.

5. The support according to claim 1, wherein said first and second locking means are of the one-way type.

6. The support according to claim 1, wherein said second locking means comprise a collar slipped onto said third segment and including a radially contractile portion for clamping said third segment, said collar being displaceable axially from and towards a seat capable of contracting said collar radially.

7. The support according to claim 6, wherein on said collar and/or on said seat are defined surfaces inclined with respect to the axial direction so as to provide an axial contraction of said collar as a result of axial displacement of said collar with respect to said seat in said insertion direction.

8. The support according to claim 6, wherein said seat is provided on a bush fixed to the end of said second segment facing said third segment.

9. The support according to claim 1, wherein said collar is secured, with respect to axial sliding, to said actuating member.

10. The support according to claim 1, wherein said second locking means comprise at least one washer external to, and coaxial with, said third segment, said washer being secured at one of its ends to said second release means and capable of pivoting about an axis perpendicular to said leg from a locking position, in which the relative sliding movement between said second segment and said third segment is prevented by the friction provided by contact between said washer and said third segment, to a release position reached when said second release means are displaced into an operating position.

11. The support according to claim 1, wherein said first locking means are identical to said second locking means.

12. The support according to claim 1, wherein said first release means are actuated by means of remote control operating means.

13. The support according to claim 12, wherein said operating means comprises for each leg a corresponding unlocking rod displaceable axially in order to transmit an axial movement to said first locking means.

14. The support according to claim 13, wherein said unlocking rod is in the shape of a curved plate dimensioned so as to be interposed between said first and second segment, and between said first locking means and said rod a bushing is interposed in order to transmit the axial thrust uniformly to said first locking means.

15. The support according to claim 14, wherein each of said unlocking rods is actuated by means of a corresponding push-button mechanism located on said support.

16. The support according to claim 14, wherein all said unlocking rods are actuated by means of a single push-button mechanism located on said support.
